(19) United States
(12) Patent Application Publication
(10) Pub. No.: US 2012/0280608 A1
(43) Pub. Date: Nov. 8, 2012

(54) REFRIGERATOR AND REFRIGERATOR DOOR

(76) Inventors: Hyungkyu PARK, Changwon-si (KR); Yongki JUNG, Changwon-si (KR); Jaehun JUNG, Changwon-si (KR)

(21) Appl. No.: 13/464,011

(22) Filed: May 4, 2012

(30) Foreign Application Priority Data
May 4, 2011 (KR) 10-2011-0042504

(51) Int. Cl. F25D 23/02; E05B 1/00

(52) U.S. Cl. 312/405; 49/460

(57) ABSTRACT

A refrigerator is provided. The refrigerator may include an opening device which facilitates the opening of a door of the refrigerator. The opening device may be linked to a handle provided on an exterior surface of the door. The opening device may be installed within the door and protrude rearward, and may be linked to the handle such that manipulation of the handle initiates operation of the opening device to space the door apart from a cabinet of the refrigerator.

### CROSS-REFERENCE TO RELATED APPLICATION(S)

This application claims priority under 35 U.S.C. §119 to Korean Application No. 10-2011-0042504 filed on May 5, 2011, whose entire disclosure is hereby incorporated by reference.

### BACKGROUND

1. Field

This relates to a refrigerator and a refrigerator door.

2. Background

Refrigerators may store items at a low temperature in an inner storage space opened or closed by a door. Such a refrigerator may cool the storage space using cool air generated by heat-exchange with a refrigerant that is converted into a low-temperature low-pressure state to maintain the storage space in a low temperature state and maintain freshness of items stored in the refrigerator. A door which easily opens and closes the storage space may provide access to the interior of the storage space. A refrigerator structure may be adapted for increased size and functionality, as well as appearance. Simplification of a structure for facilitating the coupling, opening and closing of such a door may enhance consumer satisfaction, simplify fabrication processes and reduce cost.

### BRIEF DESCRIPTION OF THE DRAWINGS

The embodiments will be described in detail with reference to the following drawings in which like reference numerals refer to like elements wherein:

FIG. 1 is a front view of a refrigerator according to an embodiment as broadly described herein.

FIG. 2 is a rear perspective view of a slide-type door of the refrigerator shown in FIG. 1.

FIG. 3 is a front exploded perspective view of the door shown in FIG. 2.

FIG. 4 is a rear exploded perspective view of the door shown in FIG. 2.

FIG. 5 is a perspective view of a finishing cap, viewed from a lower side thereof, of the door shown in FIG. 2.

FIG. 6 is a rear perspective view of an opening device of a refrigerator as embodied and broadly described herein.

FIG. 7 is an exploded perspective view of the opening device shown in FIG. 6.

FIG. 8 is a cross sectional view of the opening device shown in FIG. 6 before a door handle is manipulated.

FIG. 9 is a cross sectional view of the opening device shown in FIG. 6 when the door handle is rotated.

### DETAILED DESCRIPTION

Reference will now be made in detail to various embodiments, examples of which are illustrated in the accompanying drawings. The spirit and scope of the present disclosure, however, shall not be construed as being limited to embodiments provided herein. Rather, it will be apparent that other embodiments that fall within the spirit and scope of the present disclosure may easily be derived through adding, modifying, and deleting elements herein.

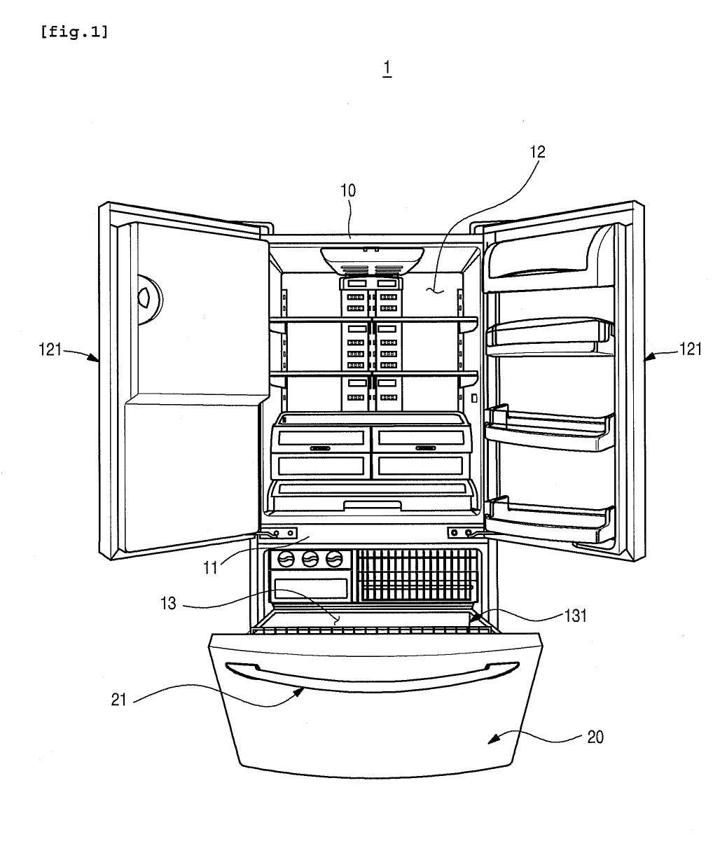

Refrigerators may be classified into various types according to arrangement of storage space(s) and disposition and configuration of door(s). In the exemplary embodiment shown in FIG. 1, simply for convenience of comprehension and description, a bottom freezer type refrigerator in which a freezing compartment is provided below a refrigerating compartment will be described. However, the present disclosure is not limited thereto, and may be applied to all types of refrigerators having various different arrangements of storage compartments and doors.

Referring to FIG. 1, a refrigerator 1 as embodied and broadly described herein may include a cabinet 10 defining a storage space therein and doors 20 and 121 opening and closing the storage space defined in the cabinet 10. The doors 20 and 121 may define an outer appearance of the refrigerator 1.

The storage space of the cabinet 10 may be vertically partitioned by a barrier 11 into a refrigerating compartment 12 provided above the barrier 11, and a freezing compartment 13 provided below the barrier 11. The doors 20 and 121 may include a refrigerating compartment door 121 opening and closing the refrigerating compartment 12 and a freezing compartment door 20 opening and closing the freezing compartment 13. Other arrangements of a barrier, compartments in the storage space, and doors may also be appropriate.

The refrigerating compartment door 121 may include a pair of doors 121 rotatably disposed on both left and right sides of a front surface of the cabinet 10, respectively, so that the pair of refrigerating compartment doors 121 may be rotated to open or close the refrigerating compartment 12.

The freezing compartment door 20 may be slidably withdrawn to open or close the freezing compartment 13. A basket 131 which is withdrawn together with the freezing compartment door 20 may be disposed at a rear side of the freezing compartment door 20. A withdrawal rail which can extend in a multi-stage manner may be disposed on the freezing compartment door 20 or the backset 131 to connect the freezing compartment door 20 or the basket 131 to the inside of the freezing compartment 13. A door handle 21 may be provided on a front surface of the freezing compartment door 20 so that, when the user grasps the door handle 21 to pull the freezing compartment door 20, the basket 131 may be slidably withdrawn together with the freezing compartment door 20. Thus, at least one portion of the basket 131 may be exposed toward the outside of the refrigerator 1 to receive items in the basket 131.

Hereinafter, the freezing compartment door 20 will be described in detail with reference to the accompanying drawings. As only the freezing compartment door is described below, the freezing compartment door will be referred to hereinafter simply as a door. In the exemplary embodiment to be discussed below, the freezing compartment door is a slide type door in which the door is slidably coupled to the refrigerator body. However, it is noted that the features discussed below may also be applied to the door of a refrigerating compartment or a freezing compartment that is either slidably or rotatably coupled to the body of the refrigerator.

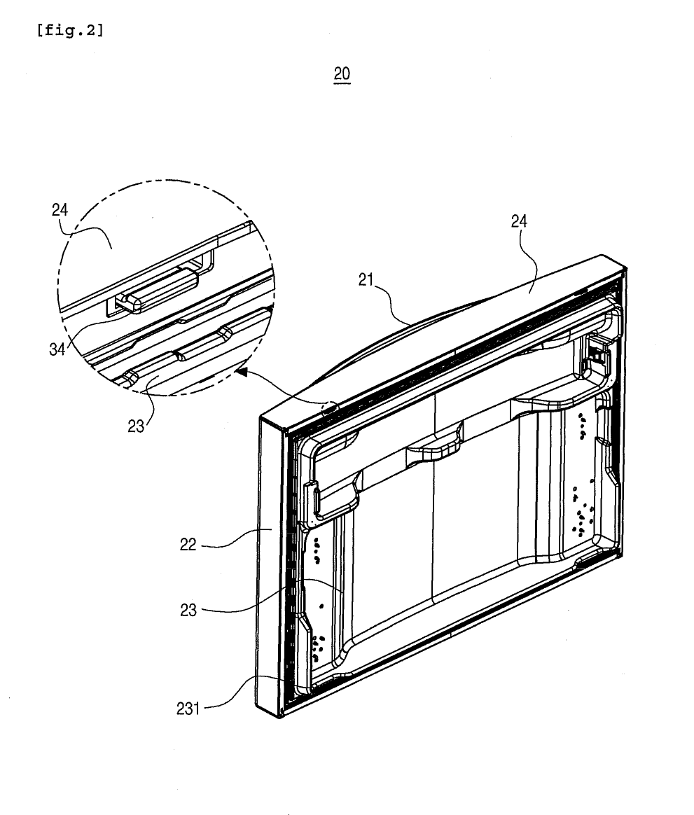

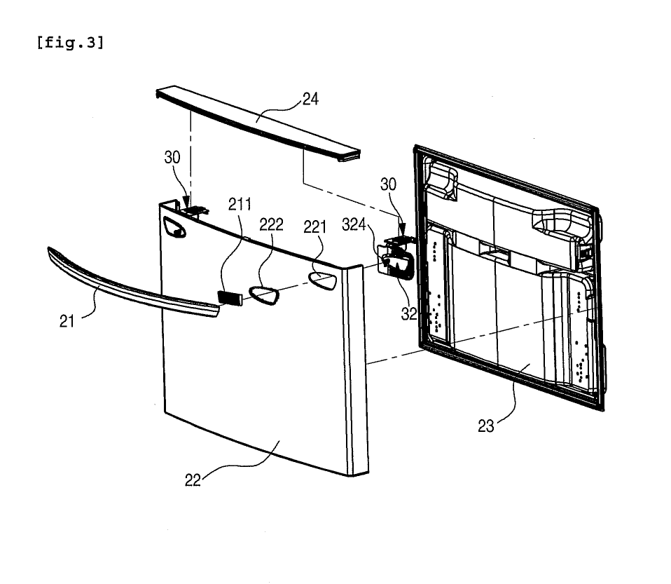

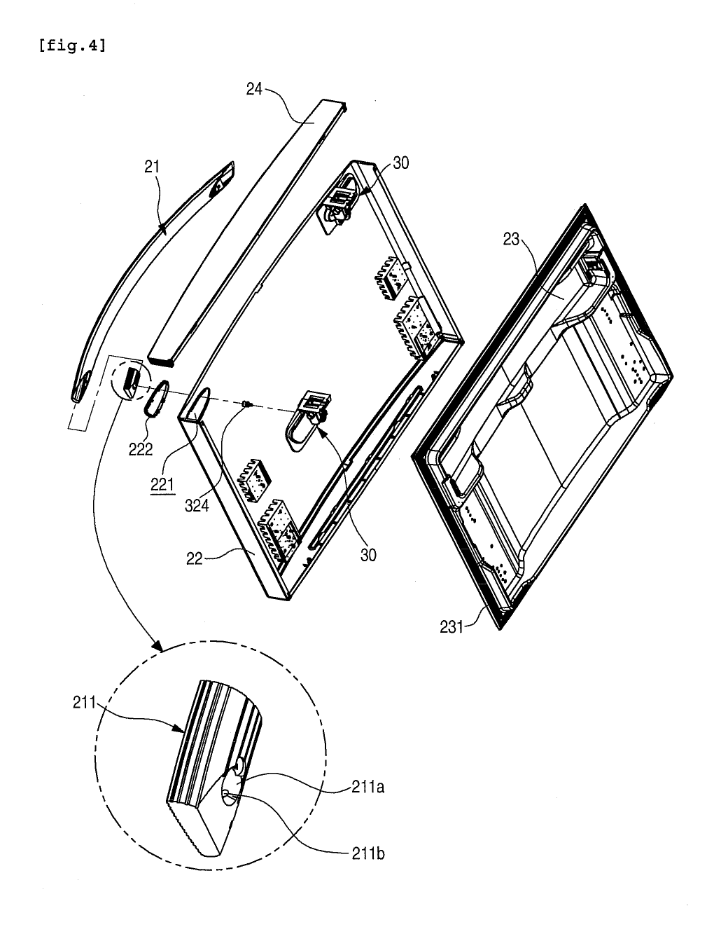

Referring to FIGS. 2 to 4, the door 20 may include an outer case 22 defining an outer appearance of a front surface thereof, a door liner 23 coupled to the outer case 22 and defining an outer appearance of a back surface thereof, and a cap deco 24, or finishing cap 24, defining an outer appearance of a top surface thereof, which together define the overall outer appearance of the door 20. The outer case 22 may be manufactured using a metal plate that may be bent to define a front surface, both left and right surfaces, and a bottom surface of the door 20. Openings 221 may be defined in the portion of the outer case 22 defining the front surface of the door 20 so that the door handle 21 may be mounted to the door 20. Each opening 221 may have a shape corresponding to a sectional shape of the two opposite ends of the door handle 21. The opening 221 may expose a portion of a handle bracket 32 of an opening device 30. Covers 222 for preventing portions of the openings 221 from being exposed is disposed around the openings 221. The openings 221 are not exposed to the outside when the door handle 21 is mounted on the door 20.

The door handle 21 may be installed at an upper portion of the door 20 and extend in a horizontal direction to allow the user to grasp the door handle 21. The door handle 21 may have a rounded shape so that each end of the door handle 21 extends gradually away from the front surface of the door 20 toward a center. The door handle 21 may have a hollow tube form.

The two opposite (i.e., left and right) ends of the door handle 21 may be opened so that a handle coupling member 211 may be inserted therein. The handle coupling member 211 may include a receiving hole 211a to receive a fastener 324 from the handle bracket 32. The handle coupling member 211 may include a threaded hole 211b to which a threaded fastener is received in a direction crossing the receiving hole 211a. Thus, the handle coupling member 211 may be threadably secured after the fastener 324 is inserted into the receiving hole 211a to maintain a coupled state between the door 20 and the handle 21. When the door handle 21 is manipulated, the handle coupling member 211 may be linked with the handle bracket 32.

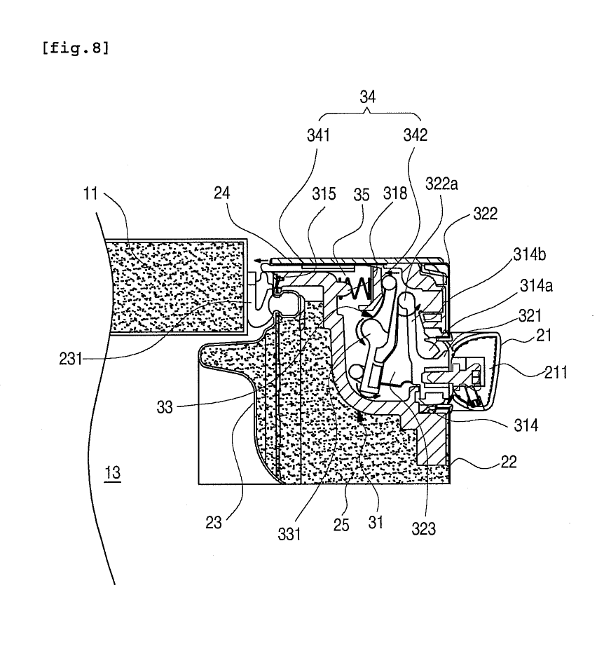

The door liner 23 may be formed of a synthetic resin, using, for example, an injection molding process, to define the back surface of the door 20. The door liner 23 may be coupled to the outer case 22. An insulation material 25 (see FIG. 8) may be foam-filled between the outer case 22 and the door liner 23.

A gasket 231 may be provided on the door liner 23 to contact a circumference of the cabinet 10 and the barrier 11 when the door 20 is closed to prevent leakage of cool air from the freezing compartment 13. The gasket 231 may be formed of, for example, a rubber or silicon material. A magnet may be provided in the gasket 231 to further improve an adhesion force.

The opening device 30 may be provided between the outer case 22 and the door liner 23, and coupled to the door handle 21. Thus, when the door handle 21 is manipulated, a slider 34 of the opening device 30 may protrude outward to form a space between the door 20 and the cabinet 10. The opening device 30 may be fixed and mounted between the outer case 22 and the door liner 23. The insulation material 25 is filled into the door 20 after the opening device 30 is mounted, so that the opening device 30 may be surrounded by the insulation material 25.

In certain embodiments, the opening device 30 may be fixed and mounted on a bottom surface of the cap 24, with a front surface of the opening device 30 closely attached to the outer case 22, a top surface of the opening device 30 closely attached to the cap 24, and a rear surface of the opening device 30 closely attached to the door liner 23. In this manner, the opening device 30 may be stably fixed so that, even though the insulation material 25 is filled into the door 20 after the opening device 30 is mounted, the opening device 30 may be maintained in its mounted position.

A detailed structure of the opening device 30 will now be described.

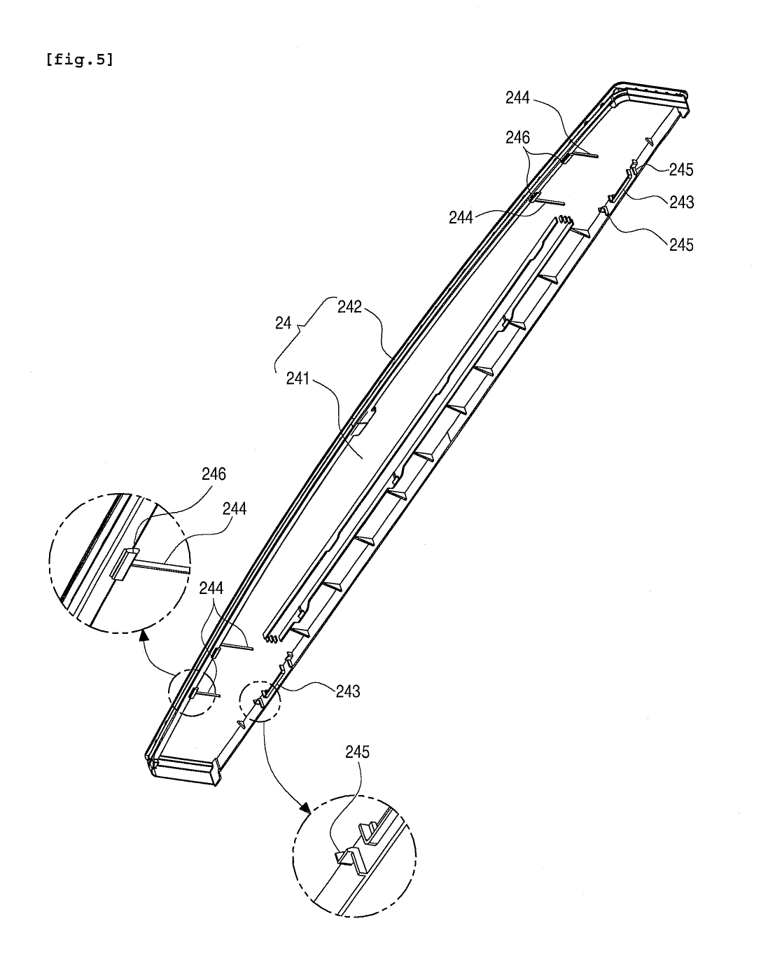

FIG. 5 is a perspective view of a finishing cap, viewed from a lower side thereof, of a refrigerator as embodied and broadly described herein.

The cap 24 may be formed of a plastic material using, for example, an injection molding process. The cap 24 may have a shape corresponding to a sectional shape of the door 20. Thus, the cap 24 may define a shape of the top surface of the door 20. The cap 24 may be coupled to the outer case 22 and the door liner 23.

In detail, the cap 24 may include a top panel 241 defining an outer appearance of a top surface thereof and a circumferential edge 242 extending along a circumference of the top panel 241.

The top panel 241 may be substantially planar to define the top surface of the door 20, with a shape corresponding to a sectional shape of the door 20. A width of the top panel 241 may gradually from its two opposite ends toward a center thereof. A rear end of the top panel 241 may be substantially linear, and a front end of the top panel 24 may have a curvature. Thus, the door 20 may have a rounded front surface, in which a central portion thereof protrudes.

The circumferential edge 242 of the cap 24 may extend downward from the circumference of the top panel 241 by a predetermined length and receive an upper end of the outer case 22 and an upper end of the door liner 23 to couple the outer case 22 to the door liner 23. A plurality of reinforcement ribs may protrude inward from the circumferential edge 242 to prevent the deformation of the circumferential edge 242 of the cap and reinforce a strength of the circumferential edge 242 and the top panel 241 of the cap 24.

A slider hole 243 may be defined in a rear surface of the circumferential edge 242 of the cap 24 to allow the slider 34 of the opening device 30 to move therethrough. The slider hole 243 may have a shape corresponding to a sectional shape of the slider 34. In alternative embodiments, a lower end of the circumferential edge 242 may be recessed to define the slider hole 243. The slider hole 243 may be may be provided at both left and right sides of the door 20 on which the opening device 30 is mounted. Also, the slider hole 243 may be defined in a corresponding position in the door liner 23, and not in the cap 24.

A mounting guide 244 may be provided on a bottom surface of the top panel 241 to guide the mounting of the opening device 30 so that the opening device 30. The mounting guide 244 may have a shape corresponding to that of the top surface of the opening device 30 to properly mount the opening device 30 in position.

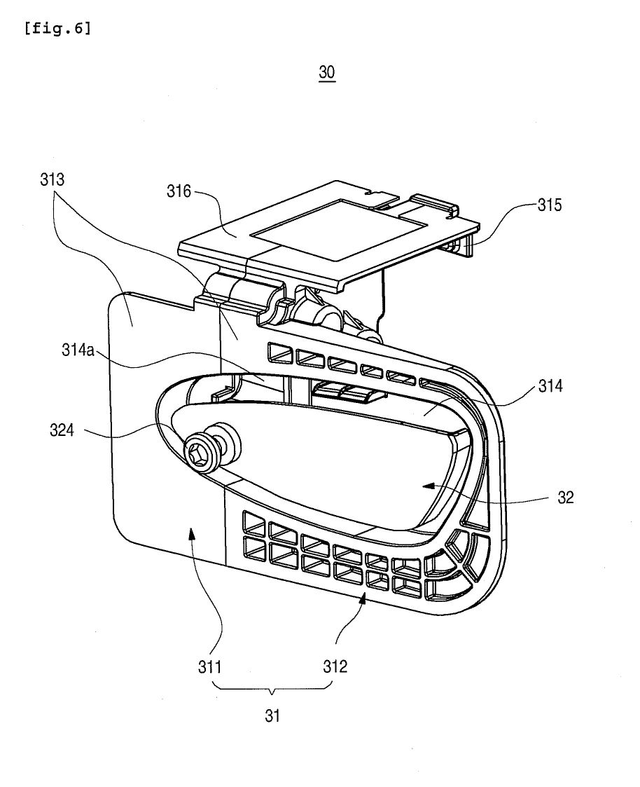

The mounting guide 244 may include a pair of ribs that define a predetermined space therebetween that receives a top mount 316 (see FIG. 6) of the opening device 30 therein. An adhesive or an adhesion sheet may be provided on a top surface of the top mount 316 to attach and fix the opening device 30 in the space provided by the mounting guide 244.

A fixing receiver 245 in which a rear end of the top mount 316 of the opening device 30 is received may be provided on a side of the circumferential edge 242 of the cap 24 corresponding to the mounting guide 244. A hook receiver 246 in which a front end of the top mount 316 may be shrink-fit, or press-fit, or hooked, may be provided on a side of the circumferential edge 242 facing the fixing receiver 245.

Thus, when the opening device 30 is mounted, the rear end of the top mount 316 may be inserted into the fixing receiver 245, and the front end of the top mount 316 may be shrink-fit, or press-fit, into the hook receiver 246 to couple the opening device 30 to the cap 24. When the opening device 30 is securely mounted in this manner, the top mount 316 may maintain the opening device 30 in position so that the slider 34 may be smoothly inserted and withdrawn through the slider hole 243.

A plurality of reinforcement ribs, in addition to those of the mounting guide 244, may be provided on the bottom surface of the top panel 241 of the cap 24 to prevent deformation of the top panel 241 and reinforce a strength of the top panel 241.

Hereinafter, a detailed structure of the opening device 30 will be described.

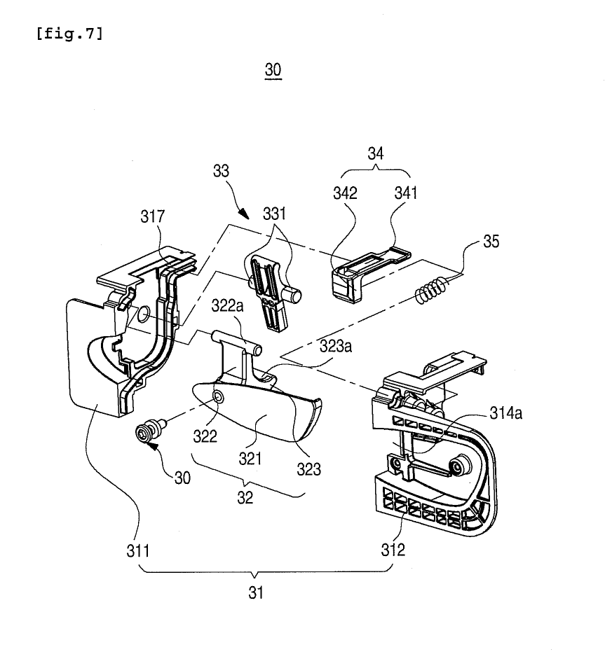

FIG. 6 is a rear perspective view and FIG. 7 is an exploded perspective view of the opening device according to an embodiment as broadly described herein.

Referring to FIGS. 6 and 7, the opening device 30 may include a cover 31 defining an outer appearance thereof, the handle bracket 32 rotatably installed in the cover 31, the slider 34 movable in front and rear directions within the cover 31, a link 33 connecting the handle bracket 32 with the slider 34, and an elastic member 35 providing an elastic force for return of the slider 34.

The cover 31 may include a left cover 311 and a right cover 312 which respectively define left and right sides thereof. The left cover 311 and the right cover 312 may be coupled to each other to define the overall outer appearance of the cover 31. A space in which the handle bracket 32, the slider 34, the link 33, and the elastic member 35 are mounted may be defined in the cover 31.

The cover 31 may include a top surface, front surface and rear surface to which the cap 24, the outer case 22, and the door liner 23 are closely attached, respectively. Even though the insulation material 25 may be filled into the door 20, the insulation material 25 is not introduced into the cover 31.

A front seal 313 may be provided on the front surface of the cover 31, corresponding to the front surfaces of the left and right covers 311 and 312. When the opening device 30 is mounted, the front seal 313 may maintain surface contact with an inner surface of the front surface of the outer case 22.

When the opening device 30 is mounted, the front seal 313 may be positioned corresponding to that of the opening 221 and closely attached to a circumference of the opening 221 so that, when the insulation material 25 is filled, it may prevent the insulation material 25 from leaking through the opening 221. An adhesive or an adhesion sheet may be provided on the front seal 313 to more stably and closely attach the front seal 313 to an inner surface of the outer case 22.

A bracket receiver 314 may be formed as a recess in the front seal 313. The bracket receiver 314 may have a shape corresponding to that of the opening 221, at a rear side of the opening 221. The bracket receiver 314 may provide a space in which a portion of the handle bracket 32 is received. The bracket receiver 314 may have a shape corresponding to that of the bracket mount 321 of the handle bracket 32. Thus, the bracket mount 321, the bracket receiver 314, and the opening 221 may have shapes corresponding to each other, with the bracket mount 321 of the handle bracket 32 exposed through the opening 221 in the front of the outer case 22.

A hole 314a in which a portion of the handle bracket 32 is inserted may be defined in the bracket receiver 314 so that the bracket mount 321 may be coupled to the door handle 21 through the hole 314a. The other portions of the handle bracket 32 may be inserted through the hole 314a and rotatably coupled within the cover 31.

A restrictor 314b, or rotation limiter 314b, for restricting/limiting a rotation angle of the handle bracket 32 to prevent the opening device 30 from being damaged when the door handle 21 is manipulated may be provided at a rear side of the hole 314a, i.e., within the cover 31. The rotation limiter 314b may protrude inward from the cover 31 so that when the handle bracket 32 is rotated over a predetermined angle, the rotation limiter 314b may contact a side of the handle bracket 32 to prevent the handle bracket 32 from being further rotated.

A rear seal 315 may be closely attached to the circumferential edge 242 of the cap 24. The rear seal 315 may be at least partially opened to allow the slider 34 to be taken in or out. Thus, when the opening device 30 is mounted, the rear seal 315 may be closely attached and fixed to a position corresponding to that of the slider hole 243. That is, the slider 34 may pass through the rear seal 315 and be inserted into and withdrawn from the slider hole 243. At least one portion of the rear seal 315 may contact an inner surface of the door liner 23 adjacent to the cap 24.

The top mount 316 is provided on a top surface of the cover 31 and mounted to the mounting guide 244 provided on an inner surface of the cap 24. That is, the top mount 316 may have a shape corresponding to that of the space provided by the mounting guide 244, so that the top mount 316 may maintain surface contact with the inner surface of the top panel 241 to maintain a stably fixed state. An adhesive or an adhesion sheet may be provided on the top mount 316 to adhere to the space provided by the mounting guide 244. Alternatively, the top mount 316 may be shrink or press fit into the mounting guide 244.

The handle bracket 32 may include the bracket mount 321, a first extension 322, and a second extension 323. The bracket mount 321 may have a shape corresponding to that of the bracket receiver 314. Alternatively, the bracket mount 321 may have a shape corresponding to that of the opening 221 in the outer case 22. The fastener 324 may be mounted on the bracket mount 321, and may be inserted into the receiving hole 211a defined in the handle coupling member 211 of the door handle and then restricted by a threaded fastener, such as, for example, a screw.

The first extension 322 may allow the handle bracket 32 to be rotatably mounted. The first extension 322 may extend upward from an upper end of the bracket mount 321. A bracket rotation shaft 322a which protrudes toward both left and right sides and is shaft-coupled to each of the left cover 311 and the right cover 312 may be disposed on an upper end of the first extension 322. The first extension 322 my have a predetermined width. The first extension 322 may be inserted into the hole 314a defined in the bracket receiver 314. When the handle bracket 32 is rotated, the first extension 322 may contact the restrictor, or rotation limiter, 314b disposed on the cover 31 to restrict or limit rotation of the handle bracket 32.

The second extension 323 extends backward from a rear surface of the bracket mount 321. A link insertion hole 323a in which the link 33 is inserted may be defined in a rear end of the second extension 323. In a state where the handle bracket 32 and the link 33 are mounted, a lower portion of the link 33 may be received in the link insertion hole 323a, so that when the handle bracket 32 is rotated, the link 33 may also be rotated.

In detail, the second extension 323 may include a pair of ribs or projections extending in a rear direction and having a width corresponding to a lower width of the link 33 to receive a lower portion of the link 33. Rear ends of the pair of extending ribs may be connected to each other to contact a lower end of the link 33 when the handle bracket 32 is rotated.

The link 33 may be rotatably mounted between the bracket rotation shaft 322a and the slider 34, which are vertically positioned with respect to each other. The link 33 may have a predetermined length, with a link rotation shaft 331 protruding outward in two opposite side directions provided at a central portion of the link 33. Thus, when the handle bracket 32 is manipulated, the lower portion of the link 33 may be pulled, and the link 33 may be rotated in a clockwise direction with respect to the link rotation shaft 331 to allow an upper portion of the link 33 to push the slider 34. Here, an upper end of the link 33 contacting the slider 34 may be rounded to smoothly move the slider 34.

The slider 34 is provided at an upper inner portion of the cover 31 and may be received into a slider mount 317 defined between the coupled left and right covers 311 and 312, and thus may be movable in front and rear directions. The slider 34 may include a push part 341 and a support part 342. The push part 341 extends in a front and rear direction and may move in the front and rear directions together with the slider mount 317. The push part 341 may protrude out of the cover 31 through the slider hole 243. The slider 34 may also include a support part 342 that extends downward from a rear end of the push part 341. Thus, in a state where the slider 34 is maximally withdrawn, the support part 342 may interfere with the slider mount 317 to restrict the movement of the slider 34 in the rear direction.

The elastic member 35 may be disposed between the support part 342 and an inner surface of the cover 31, under the slider mount 317. For example, a compression spring may be used as the elastic member 35. When the slider 34 is moved in the rear direction, the elastic member 35 may be compressed. Also, when an external force applied to the door handle 21 is removed after the slider 34 is moved in the rear direction, the slider 34 may return to an initial position thereof due to an elastic restoring force of the compressed elastic member 35. An elastic member guide 318 in which the elastic member 35 is inserted may be provided on an inner surface of the cover 31 on which the elastic member 35 is mounted to prevent the elastic member 35 from being separated.

A process in which a refrigerator including a door having an opening device as described above is opened will be described with reference to the accompanying drawings.

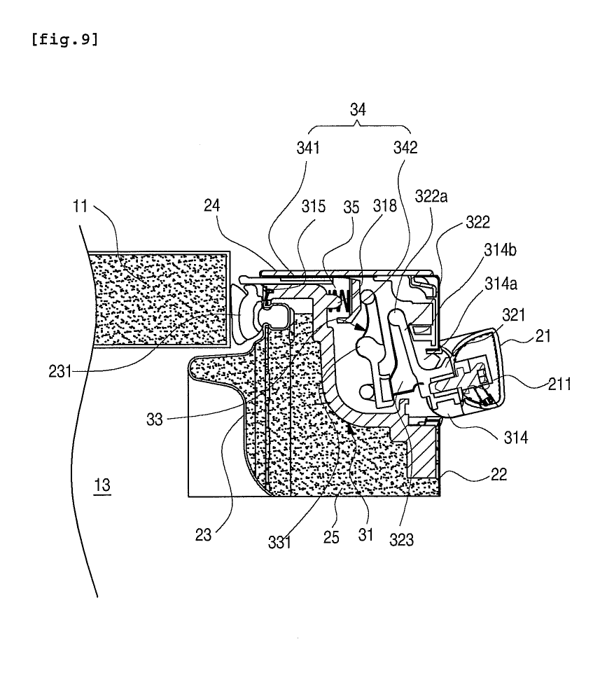

FIG. 8 is a cross sectional view of the opening device before the door handle is manipulated, and FIG. 9 is a cross sectional view of the opening device when the door handle is rotated.

Referring to FIGS. 8 and 9, in a state in which the door 20 is closed, the door 20 covers the freezing compartment 13, and the gasket 231 is closely attached to a front end of the cabinet 10 and a front end of the barrier 11 to prevent leakage of cool air from the freezing compartment 13. In this state, the door handle 21 is not rotated, and the handle bracket 32 coupled to the door handle 21 is in a state in which the handle bracket 32 covers the opening 221. In this state, the second extension 323 of the handle bracket 32 contacts the link 33, but the link 33 is not rotated. Thus, the slider 34 is not moved in the rear direction (that is, in a left direction in the view shown in FIG. 8). Thus, most of the slider 34 may be positioned within the cover 31, and only a portion of an end of the slider 34 may protrude out through the slider hole 243. If the slider 34 is not moved in the rear direction, the elastic member 35 is not compressed and the push part 341 of the slider 34 is spaced apart from a front surface of the barrier 11.

If the user then grasps the door handle 21 and pulls the door handle 21 in a front direction to open the door 20, the door handle 21 is rotated upward at a predetermined angle, as shown in FIG. 9. As the door handle 21 is rotated, the handle bracket 32 coupled to the door handle 21 is rotated, together with the door handle 21, is rotated in a counterclockwise direction (when viewed as shown in Fig, 9) with respect to the bracket rotation shaft 322a of the first extension 322. When the handle bracket 32 is rotated, a lower portion of the link 33 contacting the second extension 323 of the handle bracket 32 is pulled, thus rotating the link 33 in a counterclockwise direction with respect to the link rotation shaft 331.

As the link 33 is rotated in the counterclockwise direction, an upper end of the link 33 may push the slider 34 in a rear direction (that is, to the right in the view shown in FIG. 9). The slider 34 pushed backward by the link 33 may further protrude in the rear direction via the slider hole 243 so that an end of the push part 341 may push the front surface of the barrier 11, and the door 20 may be spaced from the cabinet 10 and the front end of the barrier 11. As the slider 34 is moved in the front direction, the elastic member 35 is compressed at the same time.

Thus, the opening of the door 20 may be assisted by the opening device 30, and the door 20 may be opened with a relatively small force.

When the door handle 21 is no longer pulled after the door 20 is opened, an external force applied to the door handle 21 is removed, the slider 34 may be moved in the front direction to return to an initial position thereof due to the elastic restoring force of the elastic member 35. Also, as the slider 34 is moved, the link 33 is rotated in a clockwise direction (when viewed in FIG. 9), and the handle bracket 32 contacting the link 33 may also be rotated in the clockwise direction by the rotation of the link 33 to return to an original position thereof. Accordingly, the handle bracket 32 may return to the state shown in FIG. 8, but with the door 20 now separated from the cabinet 10 and the barrier 11.

In this state, the user may push the door 20 toward the freezing compartment 13 to once again cover the freezing compartment 13. After the freezing compartment door 20 is completely closed, the state shown in FIG. 8 may be maintained.

A refrigerator door is provided in which an opening device, which protrudes backward by being linked with manipulation of a door handle on a front surface of a door, is disposed within the door, and the door is spaced apart from a cabinet by an operation of the opening device and easily opened by the opening device.

A refrigerator as embodied and broadly described herein may include cabinet defining a storage space, a door slidably moved to open or close the storage space; a door handle disposed on a front surface of the door, the door handle being manipulated to open the door, an opening hole passing through both sides of the front surface of the door corresponding to both left and right ends of the door handles, and an opening device disposed within the door corresponding to the opening hole, the opening device being coupled to both ends of the door handles to partially protrude backward from the door when the door handle is manipulated, thereby pushing the cabinet and assist opening of the door.

The door handle may extend so that a central portion thereof is spaced from the front surface of the door, and both ends thereof are disposed in the opening hole.

A fixing member exposed through the opening hole and coupled to the door handle may be disposed on a side of the opening device.

The door handle may have a hollow therein, a handle coupling member coupled to the fixing member may be disposed in each of both opened ends of the door handle, and a fixing hole in which the fixing member is inserted may be defined in the handle coupling member.

The opening hole may have a shape corresponding to a sectional shape of each of both left and right sides of the door handle.

The opening device may include a cover including a left cover and a right cover which are coupled to each other and respectively define outer appearances of left and right sides of the cover, a handle bracket rotatably disposed within the cover, the handle bracket being coupled to the door handle through the opening hole, a slider disposed movable in front and rear directions within the cover, the slider protruding from a rear surface of the door by manipulation of the handle bracket to push a side of the cabinet; a link rotatably disposed within the cover, the link contacting the handle bracket and the slider to link the handle bracket with the slider, and an elastic member disposed between the cover and the slider to provide an elastic force for return of the slider.

A front surface of the cover may be closely attached to an inner front surface of the door and seal a circumference of the opening hole to prevent an insulation material from leaking.

A top surface of the cover may be fixed to an inner top surface of the door.

A slider hole through which the slider is taken in or out may be further defined in a back surface of the door.

A gasket may be disposed on a back surface of the door, and the slider may be linearly moved outside the gasket.

The door may include an out case defining a front surface, a door liner coupled to the out case to define a back surface, and a cap deco covering a top side defined when the out case and the door liner are coupled to define a top surface, wherein the opening device is fixed to and mounted on a bottom surface of the cap deco.

A sealing part bent to be closely attached to the out case and the door liner may be disposed on the opening device.

The cap deco may include a top surface part defining a top surface of the door, and a circumference part extending downward along a circumference of the top surface part, wherein a slider hole through which the slider is taken in or out is further defined in the circumference part.

A mounting guide receiving an upper portion of the opening device to guide mounting of the opening device may be further disposed on the cap deco.

A fixing part hooking and restricting at least one side of the opening device to fix the opening device may be further disposed on the cap deco.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A refrigerator, comprising:
a cabinet having a storage space formed therein;
a door movably coupled to the cabinet to open and close the storage space;
a handle provided on a front surface of the door;
first and second openings that extend through opposite end portions of the front surface of the door, wherein positions of the first and second openings respectively correspond to first and second ends of the handle; and
an opening device provided within the door, positioned corresponding to the first and second openings, wherein the opening device is coupled to the first and second ends of the handle, and wherein the opening device partially protrudes backward from the door and contacts the cabinet in response to manipulation of the handle.

2. The refrigerator of claim 1, wherein the first and second ends of the handle are respectively positioned in the first and second openings in the front surface of the door, and a central portion of the handle is spaced apart from the front surface of the door.

3. The refrigerator of claim 1, wherein further comprising:
a fastener that coupled the handle to the opening device through a respective one of the first and second openings;
a handle coupler provided in each of the first and second ends of the handle and coupled to the fastener; and
a fastening hole provided in each handle coupler to receive the fastener therein.

4. The refrigerator of claim 1, wherein a shape of the first and second openings respectively corresponds to a sectional shape of the first and second ends of the handle.

5. The refrigerator of claim 1, wherein the opening device comprises:
a cover comprising a first cover coupled to a second cover so as to respectively define outer confines of first and second sides of the cover;
a handle bracket rotatably installed on the cover, the handle bracket being coupled to the handle through one of the first or second openings;
a slider movably coupled to the cover, wherein the slider moves in a front and rear direction with respect to the door and protrudes from a rear surface of the door and exerts a force on the cabinet in response to manipulation of the handle bracket;
a link rotatably provided on the cover, wherein the link connects the handle bracket with the slider; and
an elastic member provided between the cover and the slider to provide an elastic force that restores a position of the slider.

6. The refrigerator of claim 1, wherein the opening device comprises a first opening device provided at the first opening in the front surface of the door and coupled to the first end of the handle, and a second opening device provided at the first opening in the front surface of the door and coupled to the first end of the handle.

7. The refrigerator of claim 6, wherein the first and second opening devices each comprise:
a cover positioned within the door and having a receiving space formed therein;
a handle bracket rotatably installed in the cover and coupled to the handle through its respective opening in the front surface of the door;
a slider movably coupled to the cover, wherein the slider moves rearward and protrudes from a rear surface of the door and exerts a force on the cabinet in response to manipulation of the handle bracket;
a rotatable link that connects the handle bracket with the slider; and
an elastic member provided between the cover and the slider to provide an elastic restoring force to the slider.

8. The refrigerator of claim 7, wherein the cover is attached to an interior side of the front surface of the door and forms a seal along a circumference of its respective opening , and is fixed to an interior side of a top surface of the door.

9. The refrigerator of claim 7, further comprising a slider hole formed in a back surface of the door, wherein the slider moves slidably through the slider hole so as to contact the cabinet.

10. The refrigerator of claim 7, further comprising a gasket provided on a back surface of the door facing the cabinet, wherein the slider moves linearly outside the gasket.

11. A door, comprising:
an outer case that defines an exterior facing surface of the door;
a liner coupled to the outer case to define an interior facing surface of the door;
a cap that covers a top end of the coupled outer case and liner to define a top surface of the door;
an insulation material filled in a space between the outer case and the liner;
a handle rotatably provided on the outer case;
openings passing through the outer case at positions corresponding to opposite ends of the handle; and
an opening device provided between the outer case and the liner and coupled to the handle through the openings, wherein the opening device is configured to protrude outward from the space formed between the outer case and the liner, beyond the liner, in response to manipulation of the handle.

12. The door of claim 11, wherein the opening device comprises:
a first seal that contacts an inner side of the outer case facing the liner to form seal at a circumference of the openings; and
a second closely attached and fixed to an inner side of the liner facing the outer case.

13. The refrigerator door according to claim 11, wherein the opening device comprises:
a cover that defines an installation space therein, and that is surrounded by the insulation material in the space formed between the outer case and the liner;
a handle bracket rotatably provided within the cover, the handle bracket being coupled to at least one of the ends of the handle; and
a slider movably provided within the cover, wherein the slider moves in a first direction so as to extend beyond the liner and out of the door response to a manipulation force applied to the handle and handle bracket coupled thereto, and moves in a second direction upon removal of the manipulation force.

14. The door of claim 13, wherein the opening device further comprises an elastic member provided within the cover and positioned between the handle bracket and the slider, wherein the elastic member is compressed as the slider moves in the first direction and provides an elastic force that moves the slider in the second direction for return of the slider to its initial position.

15. The door of claim 13, wherein the opening device further comprises a link that rotatably couples handle bracket and the slider such that the slider moves linearly when the handle bracket is rotated.

16. The door of claim 13, wherein a shape of the handle bracket corresponds to that of the openings and is positioned within the openings.

17. The door of claim 13, wherein the cap comprises:
a top panel defining the top surface of the door;
a circumferential edge extending downward along a circumference of the top panel, the circumferential edge being coupled to the top end of the coupled outer case and the liner; and
a slider hole formed in the circumferential edge to receive the slider therethrough.

18. The door of claim 11, wherein the opening device is mounted on a bottom surface of the cap, and wherein the cap comprises:
a mounting guide provided on the bottom surface of the cap to guide and secure the opening device into position on the bottom surface of the cap; and
a fixing device provided on a circumferential edge of the cap, at a position corresponding to at least one end of the opening device corresponding to at least one of the outer case or the liner to fix the cap in position in the mounting guide.

19. The door of claim 18, wherein the fixing device comprises:
a fixing receiver formed at a first portion of the circumferential edge of the cap at which a first end of the opening device meets the liner and the cap; and
a hook receiver formed at a second portion of the circumferential edge of the cap at which a second end of the opening device meets the outer case and the cap.

20. The door of claim 11, wherein the opening device is fixed to a bottom surface of the cap by an adhesive.

21. The door of claim 11, wherein the insulation material comprises a foam insulation material filled in the space formed between the outer case and the liner after the cap on which the opening device is mounted is coupled to the outer case and the liner.

22. A refrigerator comprising the door of claim 11.
